(19) United States
(12) Patent Application Publication
(10) Pub. No.: US 2015/0213158 A1
(43) Pub. Date: Jul. 30, 2015

(54) SYSTEM AND METHOD FOR CREATING A DESIGN FOR HOME IMPROVEMENTS

(71) Applicant: HomeAdvisor, Inc., Golden, CO (US)

(72) Inventors: Christopher Steven Terrill, Denver, CO (US); David Paul Zeckser, Denver, CO (US)

(73) Assignee: HomeAdvisor, Inc., Golden, CO (US)

(21) Appl. No.: 14/167,893

(22) Filed: Jan. 29, 2014

(51) Int. Cl. G06F 17/50; G06F 17/30

(52) U.S. Cl. CPC G06F 17/5004; G06F 17/30

(57) ABSTRACT

A method for creating a home improvement design. A ‘design board’ tool disclosed herein allows users to collect pictures of room interior spaces and other images of patterns, colors, etc., assemble them on one display screen, and then edit the images to focus on what makes each picture important from a design perspective. A completed design board can be used as the foundation for remodeling or renovating a residential space. Following the creation of a design board, a professional designer can collaborate with a homeowner by exchanging ideas until a desired design is created.

### BACKGROUND

According to the U.S. Census Bureau and the U.S. Department of Housing and Urban Development, Americans spent $359 Billion on home improvement projects between 2009 and 2011. Sixty-three percent of the time, homeowners hire professionals, such as general contractors, interior designers, architects and landscaper professionals to partner in the home improvement work. What is needed is a mechanism that facilitates both the interior design process as well as interaction between a homeowner and contracting professionals.

### SUMMARY

The present system and method provides a tool that facilitates the designing of residential home improvement projects. Using a computer, a homeowner can visually integrate photographs of room interiors and images of fabric samples, paint samples and other patterns to represent the design, color and feel of a room. A ‘design board’ tool disclosed herein allows users to collect pictures, patterns, colors, etc., assemble them on one display screen, and then edit the images to focus on what makes each picture important from a design perspective. A completed design board can be used as the foundation for remodeling or renovating a residential space. Following the creation of a design board, a professional designer can collaborate with a homeowner by exchanging ideas until a desired design is created.

The present design board is a tool that helps these two parties, homeowners and home improvement professionals, work together more effectively. Design boards are a unique way to visually represent proposed home improvement projects, and provide a platform for homeowners and home improvements professionals to collaborate on the design and planning of home improvement projects.

In one embodiment, the present method for creating a home improvement design comprises a set of computer-implemented functions including generating a plurality of tagged images by tagging each of a plurality of images with a plurality of tags comprising metadata having attributes indicative of a space depicted in the image; displaying a plurality of the tagged images for inspection by a user; adding selected ones of the tagged images to a design board; providing a suggested image to be added to the design board; editing at least two of the images on the design board while the remaining images are displayed on the board; publishing the design board including original content by storing the design board in a database; and receiving an annotated copy of the design board, wherein the annotated copy includes modified original content.

### BRIEF DESCRIPTION OF THE DRAWINGS

FIG. 1A is a diagram of an exemplary embodiment showing elements of the present system;

FIG. 1B is a diagram of an exemplary design board including a plurality of photos or other images;

FIG. 2 is a flowchart showing an exemplary set of steps performed in creating a design for home improvements;

FIG. 3 is a flowchart showing an exemplary set of steps performed in suggesting additional photos for inclusion on a design board; and

FIG. 4 is a diagram showing an exemplary tagged photo and associated tags.

### DETAILED DESCRIPTION

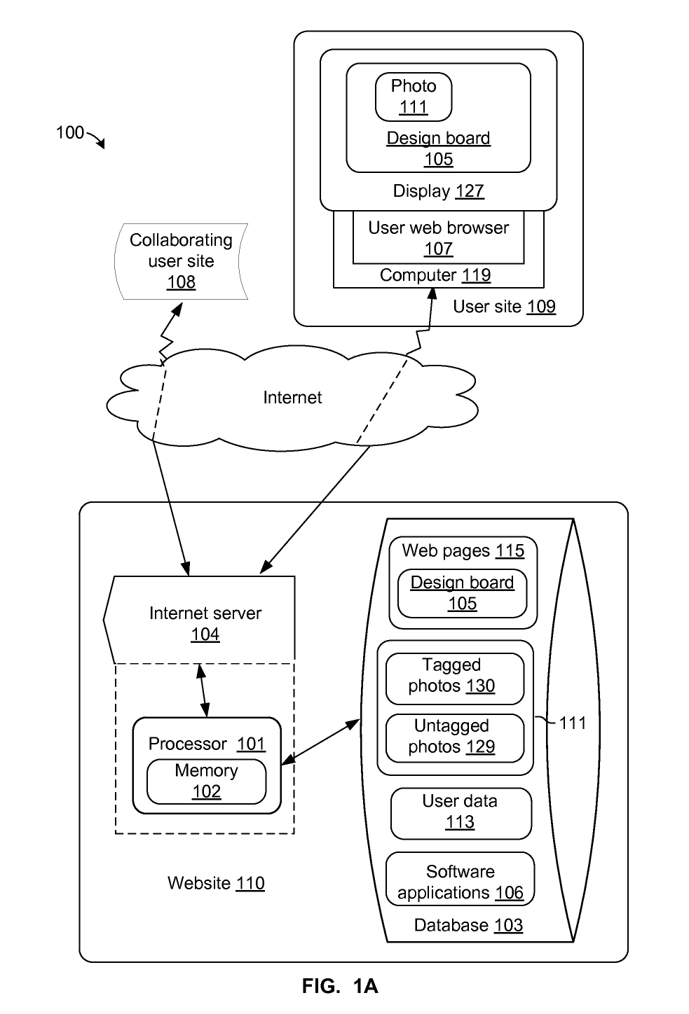

FIG. 1A is an exemplary diagram of the present system 100 for creating a design for home improvements. As shown in FIG. 1, in an exemplary embodiment, system 100 comprises a website 110 including an Internet server 104, a processor 101 and associated memory 102 (which may be included in server 104), a database 103, and one or more user sites 108, 109, each including a computer 119 with a web browser 107 and display 127.

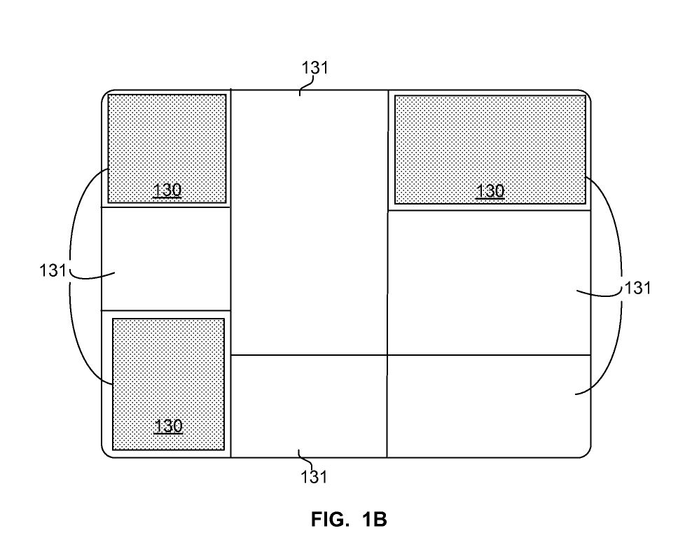

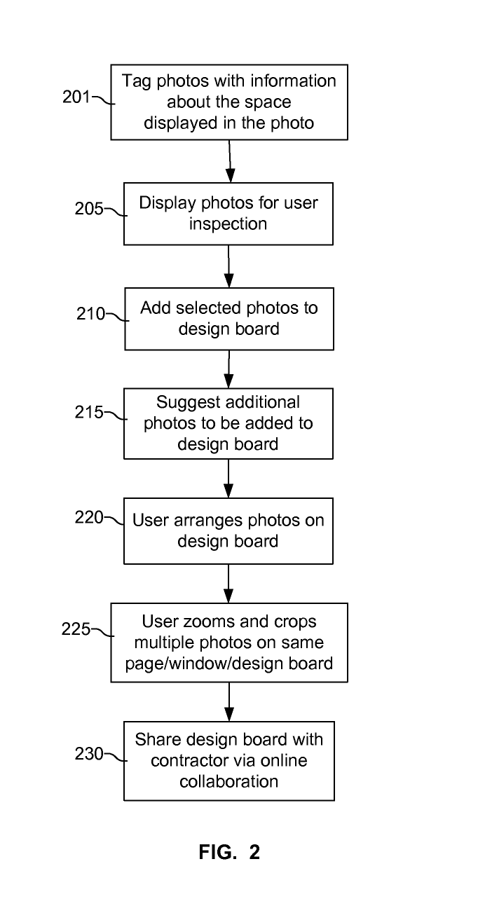

Database 103 includes web pages 115 (which may include a blank design board 105), photos 130 tagged with metadata, user data 113, and software application programs (“applications”) 106, for performing steps shown in FIGS. 2 and 3, described below.

FIG. 1B is a diagram of an exemplary design board 105 including a plurality of tagged photos or other images 130. As shown in FIG. 1B, in an exemplary embodiment, design board 105 is a page or window that provides a user with the ability to visually represent proposed home improvement projects. Users can arrange photos 130 into specific pre-designated locations 131, for example, locations 131 on a design board 105, as shown in FIG. 1B.

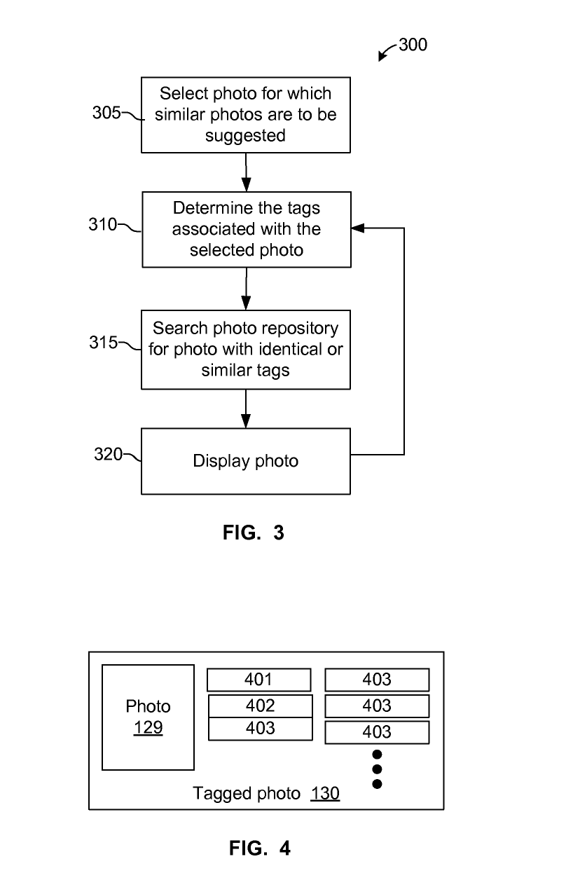

FIG. 2 is a flowchart showing an exemplary set of steps performed in creating a design for home improvements. As shown in FIG. 2, initially at step 201, photos (or other images) 129 in a photo repository 111, or stored in another source, are tagged with associated information (hereinafter referred to as Thetadata) 401-403 (shown in FIG. 4, described below) including attributes indicating some or all of the following: space (e.g., kitchen, bathroom), style (e.g., modern, traditional), size of room (e.g., square feet), cost to build, time to build, materials used, colors of materials, and brands of materials. The metadata associated with photos 129 may include multiple tags or a single tag with multiple attributes indicative of the space shown in the photo Tagged photos 130 are stored in photo repository 111 and are used in all remaining steps in the present method.

At step 205, a plurality of photos (or other images) 130 from photo repository 111 are displayed on a user's computer display 127. At step 210, certain ones of the displayed photos 130 are selected by the user and added to a design board 105 on user display 127. Design board 105 is displayed on user computer display 127 in response to a user request sent from user site 109 to an Internet website, as described below.

Applications 106, which perform the method steps and other system functions described herein, are accessed via links embedded in one or more web pages 115 sent from server 104 to computer 119. In an exemplary embodiment, applications 106 are instantiated by a user clicking on one of the links on a web page 115 displayed via computer 119 on display 127. Clicking on a link on web page 115 initiates an API call that dynamically updates the computer 119 on the user's side. In one embodiment, application 106 is downloaded from a third-party web site, in which process the application is pushed via API to the user. Applications 106 display ‘buttons’ (not shown) or other graphical mechanisms for selecting various system functions including the user-selectable functions described herein.

At step 215, using a photo suggestion algorithm 300 (described with respect to FIG. 3, below), tag metadata (described with respect to FIG. 3, below) associated with each photo 130 is used in order to suggest similar photos. Based on the information tagged in step 201, a suggestion for one or more additional photos to be included on the design board is made in step 215, by displaying photos similar to the ones a user has already viewed or selected.

Once a user has selected a number of photos or other images (e.g., 12 images) 130 that they like, and which best represents their ideas for a new space (kitchen, office, bedroom, bathroom, patio, etc.), they can move the photos to positions 131 of greater or lesser importance on the design board 105, at step 220. Moving a photo can be accomplished by tapping on it with one's finger (on a touch screen device, or clicking on it with a mouse for desktop/laptop computers) and dragging it to a desired position, where the image is dropped and switches places with the original photo, which is transferred to the original location of the photo that is replacing it.

At step 225, after a user has arranged photos in the desired locations on a design board 105, the user can edit the photos by performing editing actions including zoom in/zoom out (i.e., enlarge a selected portion of a photo), as well as pan around any photo 130 in order to focus on the specific aspect of that photo that the user is most interested in. Editing can be performed (sequentially) on two or more of the images on the design board, while the remaining images are displayed on the board. For example, if the user has a picture of a kitchen, but is actually most interested in the sink in that kitchen, then they can zoom in on the kitchen photo so that the sink is the only thing seen in that photo on the design board 105. The user can perform this step on any of the photos 130 visible on the display 127 at any time, as all of the photos 130 are visible at the same time on the same page/window/design board 105, and any one of the photos may be edited while the remaining photos are displayed on the user's display 127.

Note that steps 220 and 225 may be performed repetitively, and in any order.

At step 230, once a design board 105 is set up, a user can share the design board directly with other users. In order to share a design board 130 with other users, a design board creator (using computer 119) invokes a ‘publish’ command, which causes the design board to be stored in user data area 113 of database 103. A homeowner (e.g., a user at site 109) may share a design board 105 with a collaborating interior designer at site 108. For example, the interior designer may retrieve the design board 105 from database repository 111, and review and edit or otherwise modify the design board before sending it back to the original user (for example, the designer may draw on the design board and add notes onto the board, etc.).

A second user (for example, an interior designer at site 108) may also suggest a photo 130 with a different style or color, and insert that new photo into the first user's design board 105, which modifies the original content on the design board into new content.

FIG. 3 is a flowchart showing an exemplary algorithm for suggesting additional photos for inclusion on a design board 105. FIG. 4 is a diagram showing an exemplary tagged photo 130 and associated tags 401-403. As shown in FIG. 4, each photo 130 has associated therewith a “space” tag 401 (e.g., kitchen, bathroom, etc.), a “style” tag 402 (e.g., modern, traditional, etc.), and a plurality of ‘free form’ tags 403, which are text-only, such as “white walls”, “hardwood floors”, or “bay windows”, etc.). In total, each photo has on average approximately 20 tags indicating the contents of the tagged photo 130.

As shown in FIG. 3, in an exemplary embodiment, in order to suggest similar photos, a photo 130 on design board 105 is selected by a user at step 305. At step 310, the tags 401-403 associated with the selected photo 130 are determined. At step 315, a search of tagged photos 130 in repository 111 is performed to find photos with the same tags 401, 402, 403 as (or tags highly similar to) the selected photo 130. This search process may employ open source search software such as “Elastic Search”, which initially indexes the tags associated with each of the photos 130 in repository 111, and in performing a subsequent search, looks at the set of tags associated with the selected photo, and searches all the other photos in the database repository 111 for photos with similar tags as indexed.

At step 320, a photo 130 having identical or similar tags is located and displayed on design board 105. For example, a first photo 130 having tags that indicate “modern”, “kitchen”, “white cabinets” and “marble counters”, is displayed on display 127 in response to a user request A second photo 130 with the tags “modern”, “kitchen”, “red cabinets” and “granite counters” is then found in repository 111 and displayed as a suggestion, since those words were identical or similar in both photos.

Steps 310-320 may then repeated until the user has the desired photos 130 displayed on design board 105.

Certain changes may be made in the above methods and systems without departing from the scope of that which is described herein. It is to be noted that all matter contained in the above description or shown in the accompanying drawings is to be interpreted as illustrative and not in a limiting sense. The elements and steps shown in the present drawings may be modified in accordance with the methods described herein, and the steps shown therein may be sequenced in other configurations without departing from the spirit of the system thus described.

1. A computer-implemented method for creating a home improvement design comprising:
displaying a plurality of images on a design board,
continuing to display the plurality of images on the design board, while at least one of the images being displayed thereon is edited; and
publishing a copy of the design board including original content, by storing the design board in a database; and
receiving an annotated copy of the design board, wherein the annotated copy includes an edited version the original content stored in the database.

2. The method of claim 1, wherein each of the images has, associated therewith, a plurality of tags each comprising metadata having attributes indicative of a space depicted in the corresponding image, further including:
providing a suggested image to be added to the design board by:
determining the tags associated with a selected image;
searching a database of stored alternative images; and displaying one of the alternative images having at least one said tag with attributes at least similar to a tag associated with the selected image.

3. The method of claim 1, wherein the plurality of images on the design board are displayed while zooming in on respective selected parts of at least one of the images to enlarge the selected parts while the remaining images are displayed on the design board.

4. The method of claim 1, wherein at least two of the images being displayed on the design board are edited while the remaining images are displayed on the board.

5. A computer-implemented method for creating a home improvement design comprising:
generating a plurality of tagged images by tagging each of a plurality of images with a plurality of tags comprising metadata having attributes indicative of a space depicted in the image;
displaying a plurality of the tagged images for inspection by a user;
adding selected ones of the tagged images to a design board;
providing a suggested image to be added to the design board;
continuing to display the plurality of images on the design board, while at least one of the images being displayed thereon are edited;
publishing the design board including original content by storing the design board in a database; and
receiving an annotated copy of the design board, wherein the annotated copy includes modified original content.

6. The method of claim 5, wherein the step of providing a suggested image comprises:
determining the tags associated with a selected image;
searching a database of stored alternative images; and
displaying one of the alternative images having at least one said tag with attributes at least similar to a tag associated with the selected image.

7. The method of claim 5, wherein the plurality of images on the design board are displayed while zooming in on respective selected parts of at least two of the images to enlarge the selected parts while the remaining images are displayed on the design board.

8. A computer-implemented method for creating a home improvement design comprising:
generating a plurality of tagged images by tagging each of a plurality of images with a plurality of tags comprising metadata having attributes indicative of a space depicted in the image;
displaying a plurality of the tagged images for inspection by a user;
adding selected ones of the tagged images to a design board;
providing a suggested image to be added to the design board by:
determining the tags associated with a selected image;
searching a database of stored alternative images; and
displaying one of the alternative images having at least one said tag with attributes at least similar to a tag associated with the selected image;
continuing to display the plurality of images on the design board, while at least two of the images being displayed thereon are edited by zooming in on respective selected parts of at least one of the images to enlarge the selected parts;
publishing the design board including original content by storing the design board in a database; and
receiving an annotated copy of the design board, wherein the annotated copy includes modified original content.

9. The method of claim 8, wherein the plurality of images on the design board are displayed while zooming in on respective selected parts of at least one of the images to enlarge the selected parts while the remaining images are displayed on the design board.
